(19) United States
(12) Patent Application Publication
(10) Pub. No.: US 2026/0086269 A1
(43) Pub. Date: Mar. 26, 2026

(54) COMPOSITE COMPONENT FOR OPTICAL LIGHT-GUIDE ELEMENTS

(71) Applicants: Schott AG, Mainz (DE); SCHOTT Suisse SA, Yverdon-les-Bains (CH)

(72) Inventors: Thorsten Damm, Mainz (DE); Stefan Weidlich, Mainz (DE); Ulf Brauneck, Yverdon-les-Bains (CH); Frank Wolff, Mainz (DE); Matthias Van Gompel, Yverdon-les-Bains (CH); Clemens Ottermann, Hattersheim (DE)

(73) Assignees: Schott AG, Mainz (DE); SCHOTT Suisse SA, Yverdon-les-Bains (CH)

(21) Appl. No.: 19/339,697

(22) Filed: Sep. 25, 2025

(30) Foreign Application Priority Data
Sep. 25, 2024 (DE) 10 2024 127 743.2

(51) Int. Cl. G02B 1/10; G02B 6/10; G02B 27/01

(52) U.S. Cl. CPC G02B 1/10; G02B 6/10; G02B 27/0101

(57) ABSTRACT

An optical composite component includes a first surface; a second surface; and at least one stack with a first surface and a second surface including two or more substrates connected to one another using an adhesive layer. A surface of at least one substrate has an inorganic coating. The two or more substrates are arranged such that the substrates and the inorganic coating are alternately arranged in a stack direction of the at least one stack. An angle between a normal vector of the first surface and/or the second surface of the at least one stack and the stack direction is not 0°. The first surface of the component includes the first surface of the at least one stack and/or the second surface of the component includes the second surface of the at least one stack. The inorganic coating has at least two layers including a top layer including SiO₂.

### CROSS REFERENCE TO RELATED APPLICATIONS

This application claims priority to German Patent Application No. 10 2024 127 743.2 filed on Sep. 25, 2024, which is incorporated in its entirety herein by reference.

### BACKGROUND OF THE INVENTION

### 1. Field of the Invention

The present invention relates to an optical composite component, in particular for use as an optical light-guide element or in an optical light-guide element. Furthermore, the invention comprises the use of the optical composite component as or in an optical light-guide element, in particular in the field of augmented reality.

### 2. Description of the Related Art

Light-guide elements perform a central function in imaging optical systems for augmented reality applications. Such imaging optical systems in the field of augmented reality may, for example, be portable head-mounted systems in which an image is additionally presented to a user in their field of view. Owing to the additional image, additional information can be displayed to the user in a variety of ways, for example in the field of medicine to show a surgeon elements that are not visible, but which have been previously recorded, for example, by means of tomography. Other applications relate to navigation, for example in aircraft or vehicles. Diffractive or reflective optical elements can be used in these cases.

Reflective waveguides and their use as waveguides for augmented reality are described, for example, in US 2023/0314689 A1 and WO 2021/001841 A1. In such reflective augmented reality waveguides, light from a projector that is coupled into the waveguide is internally steered by way of one or more beam splitters, modified and reflected out of the waveguide into the eye of a user. For the production of corresponding waveguides, planar substrates are first coated and in particular bonded together with an adhesive to form a block. Plate-type elements are cut from this block at a defined angle and polished so that the coatings lie within the volume of the plate-type element.

These coatings must meet not only the optical but also the mechanical requirements. Thus, the plate-type elements must be cut and polished without the connection between the individual substrates, in particular between the top layer of the coating and the adjoining glass, exhibiting peeling. If the coated substrates are bonded together with an adhesive, a trench may form between the substrate and the coating. This trench can constitute a weak point from which partial or complete delamination of the compound can occur.

What is needed in the art is a way to overcome the disadvantages described and to provide composite components, in particular as or in optical light-guide elements, which have not only good optical properties but also increased mechanical stability.

### SUMMARY OF THE INVENTION

In some embodiments provided according to the present invention, an optical composite component for use as an optical light-guide element or in an optical light-guide element includes: a first surface; a second surface; and at least one stack with a first surface and a second surface. The at least one stack including two or more substrates connected to one another using an adhesive layer. At least one surface of at least one substrate has at least one inorganic coating. The two or more substrates are arranged in such a way that the substrates and the at least one inorganic coating are alternately arranged in a stack direction of the at least one stack. An angle between a normal vector of the first surface and/or the second surface of the at least one stack and the stack direction is not 0. The first surface of the optical composite component includes the first surface of the at least one stack and/or the second surface of the optical composite component includes the second surface of the at least one stack. The at least one inorganic coating has at least two layers. The at least two layers include a top layer include SiO₂.

In some embodiments, a use of the previously described optical composite component as an optical light-guide element or in an optical light-guide element is provided.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows schematically the side view of an embodiment of the optical composite component consisting of the at least one stack;

FIG. 2A illustrates a stack direction of an exemplary embodiment of the at least one stack;

FIG. 2B illustrates a stack direction of another exemplary embodiment of the at least one stack;

FIG. 3 illustrates an exemplary embodiment of the at least one stack, which alternately contains a substrate and a coating; and

FIG. 4 illustrates another exemplary embodiment of the at least one stack, which alternately contains a substrate and a coating.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

Exemplary embodiments disclosed herein provide an optical composite component, which may be for use as an optical light-guide element or in an optical light-guide element, wherein the optical composite component has a first surface and a second surface, wherein the optical composite component comprises at least one stack with a first and a second surface, wherein the stack comprises two or more substrates connected to one another using an adhesive layer, wherein at least one surface of at least one substrate has at least one inorganic coating, wherein the two or more substrates are arranged in such a way that the substrates and the at least one inorganic coating are alternately arranged in the stack direction, wherein the angle between the normal vector of the first and/or second surface of the at least one stack and the stack direction is not 0°, wherein the first surface of the composite component comprises the first surface of the at least one stack and/or the second surface of the composite component comprises the second surface of the at least one stack, and wherein the at least one inorganic coating has at least two layers, with the top layer comprising SiO₂.

It has been found that composite components in which the top layer of the coating comprises or consists of SiO₂ have a higher mechanical stability and in particular exhibit better bonding among the individual substrates by way of the adhesive.

According to the invention, at least one main surface of at least one substrate has at least one inorganic coating. In some embodiments, a main surface of the at least one substrate has at least one inorganic coating. In some embodiments, both main surfaces have at least one inorganic coating.

Unless otherwise specified, in connection with the present invention, the first and/or second surface of a particular component is the first and/or second main surface of the respective component.

The at least one inorganic coating has at least two layers, wherein the top layer comprises or consists of SiO₂. The inorganic coating comprises not only the top layer but also at least one or more further layers, wherein the further layers may comprise one or more components selected from one or more oxides, one or more fluorides, one or more nitrides, one or more oxinitrides, one or more sulfides, one or more selenides, one or more metals and combinations of two or more of them. For example, the inorganic coating comprises or consists of one or more components selected from one or more metal oxides, one or more metal fluorides, one or more metal nitrides and combinations of two or more of them.

Oxides according to the present invention can be optionally selected from silicon oxide, aluminium oxide, hafnium oxide, tantalum oxide, niobium oxide, titanium oxide, zirconium oxide, yttrium oxide, praseodymium oxide, scandium oxide, tin oxide, indium oxide and combinations of two or more of them. In some embodiments, combinations of two or more oxides comprise mixed oxides.

Fluorides within the meaning of the invention can be optionally selected from aluminium fluoride, magnesium fluoride, neodymium fluoride, lanthanum fluoride, yttrium fluoride, gadolinium fluoride, ytterbium fluoride and combinations of two or more of them.

Nitrides within the meaning of the present invention can be optionally selected from aluminium nitride, silicon nitride and combinations thereof.

Oxynitrides within the meaning of the present invention can be optionally selected from aluminium oxinitride, silicon oxinitride and combinations thereof.

Metals within the meaning of the present invention can be optionally selected from aluminium, silver, gold, and combinations thereof. Optionally, the combination of two or more metals is an alloy. In some embodiments, the metallic layer has a thickness of not more than 10 nm to ensure sufficient transparency.

In some embodiments, the inorganic coating comprises at least one dielectric layer; in some embodiments all layers of the inorganic coating are dielectric layers.

In some embodiments, the inorganic coating comprises at least one metallic layer consisting of or comprising at least one metal, for example Ag, wherein the at least one metallic layer has a thickness of not more than 10 nm.

In some embodiments, the layer of the at least one inorganic coating which is located directly below the top layer does not comprise SiO₂.

In some embodiments, the inorganic coating comprises, in addition to the top layer, one or more further layers, with the further layers optionally being selected from TiO₂, Ta₂O₅, HfO₂, Nb₂O₅, ZrO₂, Al₂O₃, SiO₂, MgF₂ and SiAl oxide with an atomic ratio of silicon to aluminium (Si:Al) in the range of 1:0.20 to 1:0.05, optionally from 1:0.08 to 0.18, such as from 1:0.115.

Optionally, the at least one inorganic coating has 2 to 100 layers, optionally 4 to 50 layers, optionally 5 to 40 layers or 7 to 35 layers.

Optionally, the respective layers have a thickness of 1 nm to 200 nm, optionally from 4 to 100 nm, optionally from 8 nm to 800 nm or from 10 nm to 700 nm, optionally from 15 nm to 600 nm or from 15 nm to 500 nm.

Optionally, the at least one inorganic coating has a thickness of 200 nm to 3000 nm, optionally from 300 nm to 2500 nm, optionally from 400 nm to 2000 nm or from 500 to 1700 nm, optionally from 600 nm to 1600 nm.

Optionally, the inorganic coating has a refractive index of 1.44 to 3.00, from 1.45 to 2.50, from 1.47 to 2.20 or from 1.51 to 1.90 or from 1.60 to 1.90. If the coating comprises more than one material, the indicated refractive index is the mean refractive index of the entire area of the inorganic coating.

According to the invention, the top layer of the coating comprises SiO₂. In some embodiments, the top layer consists substantially of SiO₂. Such layers typically exhibit good bonding to the adjoining substrate or the connecting adhesive layer.

It is understood that the top layer of the coating is the layer that is in direct contact with the adhesive layer.

When this description states that a layer is free of a component, is substantially free of a component or does not contain a specific component, it means that said component may at most be present as an impurity in the layer. This means that it is not added in significant amounts. According to the invention, amounts that are not significant are amounts of less than 100 ppm, optionally less than 50 ppm and optionally less than 10 ppm (m/m).

In some embodiments, it may be advantageous if the top layer comprises further materials in addition to SiO₂, for example, to adapt the refractive index of the top layer to the refractive index of the adjoining substrate. Therefore, the top layer in some embodiments comprises SiO₂ and at least one further material, wherein the at least one further material optionally has a refractive index which is higher than the refractive index of SiO₂. Optionally, the at least one further material is selected from the group consisting of Al₂O₃, ZrO₂, Nb₂O₅, TiO₂, HfO₂ and Ta₂O₅ and combinations of two or more of them. However, with regard to the adhesive properties of the top layer, it may be advantageous to limit the content of the at least one further material in the top layer. Optionally, the top layer comprises not more than 50% by weight, optionally not more than 30% by weight, optionally not more than 20% by weight, optionally not more than 10% by weight of the at least one further material. Optionally, the top layer comprises at least 50% by weight, optionally at least 70% by weight, optionally at least 80% by weight or at least 90% by weight of SiO₂.

Optionally, the at least one inorganic coating has a refractive index corresponding to the refractive index of the at least one substrate, wherein the ratio of the refractive index of the at least one substrate to the refractive index of the at least one inorganic coating is optionally in the range of 0.8 to 1.25, optionally from 0.85 to 1.2, optionally from 0.9 to 1.1, optionally 0.95 and 1.05, optionally 0.98 and 1.03.

Optionally, the refractive index of the coating is an average refractive index of the coating. For example, the values of the refractive index mentioned previously for the coating could correspond to the value that can be obtained by determining the integral of the refractive index along the thickness of the coating. In the case of a coating with discrete layers with a uniform refractive index across each individual layer, the integral could become a sum. For example, the following equation can be used to determine the average refractive index of the coating n for a total thickness of the coating (in particular measured along the first direction), which is d, and the local refractive index of the coating/its layers n(x):

$$\overline{n} = {\int }_{0}^{d} n ( x ) dx / {\int }_{0}^{d} d x .$$

For example, the refractive index of the coating can be considered to be matched to that of the substrate if nₛ satisfies the condition n̅=nₛ for the refractive index of the substrate.

The refractive index of the coating is optionally a weighted average of the local refractive index over the coating thickness.

Optionally, the refractive index of the coating is identical to the refractive index of the substrate. The values of the refractive indices are optionally identical if the ratio of the refractive index of the coating and the refractive index of the substrate is from 0.9 to 1.1, optionally from 0.95 to 1.05.

Optionally, the refractive index of the coating (and, if applicable, of the substrate) is specified for a wavelength of 587 nm (n_{d}).

Optionally, the top layer of the at least one inorganic coating has a thickness of 1 nm to 500 nm, optionally from 10 nm to 400 nm, optionally at least 15 nm to 200 nm.

In some embodiments, it may be advantageous if the top layer is sufficiently thin to have no optical effect. In these embodiments, the thickness of the top layer is optionally limited to not more than 15 nm, optionally not more than 10 nm or not more than 5 nm. Optionally, the top layer has a thickness of at least 1 nm.

In some embodiments, the top layer is an optically active layer and optionally has a thickness of more than 15 nm, optionally more than 20 nm, optionally more than 30 nm, or more than 40 nm and/or not more than 500 nm, optionally not more than 400 nm, optionally not more than 300 nm or not more than 200 nm.

Optionally, the top layer has a refractive index which deviates from the refractive index of the at least one substrate by not more than 0.50, optionally not more than 0.40, optionally by not more than 0.30.

In the at least one stack, the two or more substrates are arranged in such a way that the two or more substrates and the at least one inorganic coating are alternately arranged along the stack direction. The two or more substrates are optionally connected to each other via their surfaces, wherein the coating together with the adhesive layer represents the interface between two connected substrates.

According to the invention, the at least one stack has, not taking into account the adhesive layers, alternating substrates and inorganic coatings.

Optionally, the stack provided according to the invention comprises 2 to 50, optionally 4 to 45, optionally 6 to 35 or 6 to 30, optionally 8 to 25 or 8 to 20 substrates.

Optionally, the stack provided according to the invention comprises, not taking into account the adhesive layers, a substrate(S) and an inorganic coating (B) in alternation, wherein the combination (S-B) is repeated x times. In other words, the stack comprises the sequence (S-B)ₓ. In some embodiments, the stack comprises the sequence (S-B)ₓ-S. In some embodiments, the stack comprises the sequence B-(S-B)ₓ.

Optionally, the at least one inorganic coating has a modulus of elasticity of 60 GPa to 200 GPa, optionally from 80 GPa to 180 GPa, optionally from 90 GPa to 160 GPa, optionally from 100 GPa to 150 GPa. In inorganic coatings containing two or more coating materials, the modulus of elasticity corresponds to the average Young's modulus of the entire area of the inorganic coating.

Substrates provided according to the present invention each have a first and a second surface, which are optionally parallel to each other. The first and second surfaces of a substrate are the so-called “main surfaces” of the substrates. The distance from the first to the second surface of the substrate is also referred to below as the thickness of the substrate.

Optionally, the substrates comprise or consist of a glass, a glass ceramic, an opto-ceramic or a plastic, optionally glass and/or plastic. Optionally, the substrates consist of a glass or a plastic.

Optionally, the substrates have a thickness of 0.2 mm to 2.0 mm, optionally from 0.3 mm to 1.8 mm, optionally from 0.4 to 1.7 mm and optionally from 0.5 to 1.5 mm.

The thicknesses of the substrates in the at least one stack can be different or identical, optionally the thicknesses of the substrates in the at least one stack are identical.

Optionally, it is a glass having a refractive index n_{d} in the range of 1.45 to 2.30, optionally from 1.47 to 2.10, optionally from 1.50 to 2.00, likewise optionally from 1.47 to 1.8.

Optionally, the two or more substrates comprise a material which is transparent at least for a wavelength in the range from 450 nm to 650 nm, optionally for all wavelengths in the range from 450 nm to 650 nm, or optionally consist thereof.

In some embodiments, the at least one stack comprises substrates of different materials, optionally, however, all substrates in the at least one stack comprise the same material, optionally they consist thereof.

In embodiments in which the two or more substrates comprise or consist of a glass, the glass is optionally a silicate glass, for example a barium-containing silicate glass. For example, the substrate may comprise or consist of a flint glass or crown glass. Optionally, the glass is selected from alkaline-earth-containing flint glass, a barium flint glass, a barium crown glass, a boron-containing crown glass, a lanthanum flint glass, a lanthanum crown glass and combinations thereof.

Optionally, the substrate has a modulus of elasticity of 50 GPa to 150 GPa, optionally from 55 GPa to 100 GPa, optionally from 65 GPa to 95 GPa, optionally from 75 GPa to 90 GPa.

According to the invention, the at least one stack comprises at least one adhesive layer. The adhesive layer serves to connect the two or more substrates via their surfaces, optionally their full surfaces, wherein the substrates are connected to each other via their main surfaces.

Optionally, the adhesive layer comprises a light-curing adhesive, optionally a UV-curing adhesive.

In some embodiments, the adhesive layer has a layer thickness of 10 nm to 20 μm, optionally from 20 nm to 15 μm, optionally from 50 nm to 10 μm, optionally from 100 nm to 7 μm, optionally from 200 nm to 5 μm.

Optionally, the adhesive layer has a layer thickness of 10 nm to 20 nm, optionally from 20 nm to 15 nm, optionally from 50 nm to 10 nm, optionally from 100 nm to 7 μm, optionally from 200 nm to 5 μm. Optionally, the adhesive layer has a layer thickness of 0.5 μm to 4.5 μm, optionally from 1.0 μm to 4.0 μm, optionally from 1.5 μm to 3.5 μm, optionally from 2.0 μm to 3.0 μm. The adhesive layer optionally has a homogeneous thickness over the entire region covered with it of a substrate surface.

Optionally, the adhesive layer satisfies at least one of the following conditions:
i) a total thickness variation (TTV) of less than 20 μm;
ii) no inclusions with a particle size greater than the thickness of the adhesive layer;
iii) a refractive index n_{d}, which differs from the refractive index n_{d} of the substrates by not more than 0.005, optionally not more than 0.004, optionally not more than 0.003, or not more than 0.002, optionally not more than 0.001.

According to the invention, the adhesive layer has a total thickness variation, hereinafter also called “TTV”, of less than 20 μm, optionally less than 15 μm, optionally less than 12 μm, optionally less than 10 μm, optionally less than 7 μm, optionally less than 5 μm, optionally less than 4 μm or less than 3 μm, optionally less than 2.5 μm or less than 2 μm, optionally less than 1.5 μm or less than 1 μm, optionally less than 0.75 μm, optionally less than 0.5 μm, optionally less than 0.3 μm or 0.2 μm. The above explanations for the meaning and ascertainment of the TTV apply here in the same way.

Optionally, the adhesive layer does not comprise inclusions having a particle size greater than the thickness of the adhesive layer. Inclusions within the meaning of the present invention are, for example, impurities and bubbles, such as air bubbles.

In some embodiments, the at least one adhesive layer is made of acrylate adhesives, epoxy adhesives, silicone adhesives, polyurethane adhesives, acrylate adhesives filled with nanoparticles, epoxy adhesives filled with nanoparticles, silicone adhesives filled with nano particles or polyurethane adhesives filled with nanoparticles, sol-gel adhesive systems, optionally of an acrylate adhesive, an epoxy adhesive, a silicone adhesive or a polyurethane adhesive, optionally an acrylate adhesive.

The adhesive can be a light-curing adhesive, a heat-curing adhesive or an anaerobically curing adhesive. It is optionally a light-curing adhesive, optionally a UV-curing adhesive.

Optionally, the adhesive is a light-curing, optionally UV-curing, acrylate adhesive.

Optionally, the adhesive layer has a refractive index n_{d}, which differs from the refractive index n_{d} of the two or more substrates by not more than 0.005, optionally not more than 0.004, optionally not more than 0.003 or not more than 0.002, optionally not more than 0.001.

Optionally, the UV-curing adhesive is an optically clear adhesive, which optionally has a refractive index n_{d}, which corresponds substantially to the refractive index n_{d} of the substrates and which optionally exhibits low shrinkage during curing. This allows stress to be avoided or at least minimized when adhesively bonding the two or more substrates.

Optionally, the adhesive layer has a modulus of elasticity of 5000 MPa to 15 000 MPa, optionally from 6000 MPa to 12 000 MPa, optionally from 7000 MPa to 10 000 MPa, optionally from 7500 MPa to 9000 MPa.

In some embodiments, the optical composite component consists of the at least one stack.

The at least one stack is optionally produced by a method comprising the following steps:
a) providing two or more plate-type substrates having a first and a second main surface parallel to each other, and wherein at least the first or the second main surface of at least one plate-type substrate is provided with an inorganic coating,
b) connecting the two or more plate-type substrates with an adhesive layer to obtain a composite,
c) optionally one or more separation steps and/or one or more connecting steps.

In some embodiments, the production of the stack comprises the method described in DE 10 2023 108 065.2.

In some embodiments provided according to the invention, the optical composite component comprises at least one further stack and/or at least one further optical component, selected from optical filters, in particular interference filters, mirrors, optical light-guide elements and polarization-optical elements.

Optical components within the meaning of the invention are components which comprise one or more optically relevant regions, wherein an optically relevant region is understood to mean a region of a component which is located in the beam path of the optically relevant light. Optically relevant light within the meaning of the present invention is the light that contributes to the resulting image. Optically relevant regions of an optical component provided according to the invention are the regions which lie in the beam path of the light. An optically relevant region of the surface of a particular component within the meaning of the invention, is understood to be any surface which lies in the beam path of the optically relevant light, comprising both surfaces on the light-incidence and on the light-exit side and surfaces which reflect or deflect the incident light beam.

In some embodiments, the composite components furthermore comprises further optically non-relevant components, optionally optically non-relevant components, comprising or consisting of the material of which at least one substrate consists or which at least one substrate comprises.

In some embodiments, the composite component comprises a polarization-optical element, wherein the polarization-optical element has a first surface and a second surface, wherein the first surface of the composite component comprises the first surface of the polarization-optical element and/or the second surface of the composite component comprises the second surface of the polarization-optical element.

Polarization-optical elements within the meaning of the present invention are elements which generate the pitch difference between two partial waves which are linearly polarized perpendicular to each other and whose oscillation directions correspond to the marked directions of this optical element. In particular, such polarization-optical elements serve to select a specific polarization of the light and/or to generate or rotate a specific polarization direction of the light. Such polarization-optical elements can be, for example, reflective, transmitting, dichroic and birefringent elements.

Optionally, the polarization-optical element comprises a birefringent material, optionally a birefringent crystal or a birefringent polymer. Optionally, the birefringent material is a birefringent crystal, in particular quartz, MgF₂ or CaF₂, or a birefringent polymer. Optionally, the birefringent material is quartz.

The polarization-optical element optionally has a length of 10 mm to 300 mm, optionally from 20 mm to 150 mm, optionally 30 mm to 100 mm, for example from 50 mm to 80 mm and/or a width of 1 μm to 100 μm, optionally from 5 μm to 50 μm, and optionally from 20 μm to 40 μm.

Optionally, the following applies to the optical composite component:
i) the first surface and/or the second surface of the composite component has a roughness R_{q} of <5 nm; and/or
ii) the composite component has, based on the first surface and the second surface, a TTV of less than 10 μm; and/or
iii) the composite component has, based on the first surface and the second surface, a warp of <100 μm; and/or
iv) the composite component has, based on the first surface and the second surface, a bow of <100 μm.

Optionally, the optical composite component has a total thickness variation, hereinafter also called “TTV”, of less than 10 μm, optionally less than 8 μm, optionally less than 5 μm, optionally less than 4 μm, optionally less than 3 μm, optionally less than 2 μm or less than 1 μm, optionally less than 0.75 μm, optionally less than 0.5 μm.

In some embodiments, the optical composite component has a TTV of at least 0.1 μm or at least 0.2 μm. Such optical composite components may be particularly advantageous for the use of the manufactured stacks or the light-guide elements made therefrom in augmented reality applications. Optical composite components with a low TTV can be produced, for example, by suitable abrasive processes such as grinding, lapping and/or polishing and/or by ion beam processing as described in the German patent application DE 10 2021 125 476.0, which has not yet been published.

Optionally, the first and/or the second surfaces, optionally the first and the second surfaces of the optical composite component, have a roughness R_{q} of 0.1 nm to 5 nm, optionally not more than 5 nm, optionally less than 5 nm, optionally less than 4 nm or less than 3 nm, optionally less than 2 nm or less than 1.5 nm or optionally less than 1 nm or less than 0.5 nm.

Optionally, the optical composite component has a warp of more than 1 μm, more than 5 μm or more than 10 μm, and/or less than 100 μm, optionally less than 50 μm, optionally less than 20 μm and/or a bow of more than 1 μm, more than 5 μm or more than 10 μm, and/or less than 100 μm, optionally less than 50 μm, optionally less than 20 μm. Optionally, the optical composite component has a bow and/or a warp of less than 0.1%, optionally less than 0.075%, optionally less than 0.05%, optionally less than 0.01%, of the diameter. Optionally, warp and bow are ascertained according to SEMI3D1203152015.

The warp and bow are parameters that are used to express the shape of an optical composite that rests on a surface and is therefore not held by, for example, a chuck. The composite is therefore held free of forces or rests on a planar surface. The center surface in the thickness direction of the composite acts as the measurement plane, wherein the most suitable plane for the measurement plane is assumed to be a reference plane. The warp represents the maximum value of the offset from the reference plane to the measurement plane. The bow represents the difference between the reference plane and the measurement plane at the center of the substrate. If the composite is supported by a locally limited support, such as is the case in a 3-point bearing or fork holder in the periphery, additional warps occur under the influence of gravitational forces, which is referred to as sagging. The shape of these warps therefore substantially depends on the geometric arrangement of the support. Furthermore, the mechanical properties of the material and the geometric shape of the composite are parameters that determine the sagging.

In some embodiments, the first surface and the second surface of the optical composite component are parallel to each other and/or the first surface of the at least one stack and the second surface of the at least one stack are parallel to each other.

The distance from the first to the second surface of the optical composite component is also referred to below as the thickness of the composite component. Optionally, the optical composite component and/or the at least one stack has a thickness of 0.2 mm to 2.0 mm, optionally from 0.3 mm to 1.8 mm, optionally from 0.4 to 1.7 mm and optionally from 0.5 to 1.5 mm.

In embodiments in which the first surface and the second surface of the optical composite component are not parallel to each other, the thickness of the composite component varies, wherein the maximum thickness and the minimum thickness of the composite component are in the range of 0.2 mm to 2.0 mm, optionally from 0.3 mm to 1.8 mm, optionally from 0.4 to 1.7 mm and optionally from 0.5 to 1.5 mm.

The optical composite component is optionally plate-type, wherein the first and the second surface are opposite each other, optionally parallel to each other. Optionally, the maximum distance of the first surface from the second surface, in other words the thickness of the optical composite component, is smaller than the maximum width and/or the maximum length or the maximum diameter of the first or second surface of the optical composite component.

The optionally plate-type optical composite component can-based on the first and second surface-be angular or round, or have both corners and rounded regions.

Optionally, the optical composite component has a length and/or width of 10 mm to 300 mm, optionally from 20 mm to 150 mm, optionally from 30 mm to 100 mm, for example from 50 mm to 80 mm and/or a diameter of 10 mm to 300 mm, optionally 15 mm to 200 mm, optionally from 20 mm to 150 mm, optionally 30 mm to 100 mm, for example from 50 mm to 80 mm

According to the invention, the optical composite component has at least one stack having a first and a second surface, wherein the stack comprises two or more substrates which are connected to each other with an adhesive layer, wherein at least one main surface of at least one substrate has at least one inorganic coating, wherein the two or more substrates are arranged in such a way that substrates and the at least one inorganic coating are arranged alternately along the stack direction.

According to the invention, the angle between the normal vector of the first and/or the second surface of the at least one stack and the stack direction is not 0°.

Stack direction is understood to be the stacking along the normal vector of the interface between the at least two substrates. Optionally, the interface is formed by the inorganic coating and/or the adhesive layer.

According to the invention, the first surface of the optical composite component comprises the first surface of the at least one stack and/or the second surface of the optical composite component comprises the second surface of the at least one stack. In other words, the first surface of the first stack forms at least part of the first surface of the optical composite component and/or the second surface of the at least one stack forms at least part of the second surface of the optical composite component. The first and/or the second surface of the optical composite component therefore comprises regions forming interfaces between the two or more substrates, optionally the surface of the optical composite component comprises regions comprising an inorganic coating and/or adhesive layers.

In some embodiments, the optical composite component consists of the at least one stack, wherein the first surface of the optical composite component consists of the first surface of the at least one stack and the second surface of the optical composite component consists of the second surface of the at least one stack.

In some embodiments, the magnitude of the angle between the normal vector of the first and/or the second surface of the at least one stack and the stack direction is 90°.

In some embodiments, the magnitude of the angle between the normal vector of the first and/or second surface of the at least one stack and the stack direction is >10°, optionally >20°, optionally >45°, optionally >50°, optionally >55° or >60°.

Optionally, the magnitude of the angle between the normal vector of the first and/or the second surface of the at least one stack and the stack direction lies in a range of greater than 10° to 90°, optionally greater than 20° to 90°, optionally greater than 45° and 90°, optionally greater than 50° to 90° and optionally greater than 55° to 90° or greater than 60° and 90°.

Optionally, the first and/or the second surface of the at least one stack is planar, optionally the first and the second surface of the at least one stack are planar.

Optionally, the first and/or the second surface of the optical composite component is planar, optionally the first and the second surface of the optical composite component are planar.

Optionally, the optically relevant regions of the first and/or the second surfaces of the composite component are planar.

“Being planar” or “planar” within the meaning of the invention means that the surface under consideration does not deviate from the plane formed by the surface under consideration by more than a defined magnitude.

Optionally, “being planar” or “planar” in relation to the at least one stack means that the first and/or the second surface of the at least one stack does not deviate from the plane by more than 1000 nm, optionally more than 500 nm, optionally not more than 300 nm, optionally not more than 150 nm or not more than 120 nm, optionally not more than 100 nm and optionally not more than 80 nm or not more than 70 nm, optionally not more than 60 nm or 50 nm.

Optionally, “being planar” or “planar” in connection with the optical composite component means that the first and/or the second surface of the optical composite component deviates from the plane by not more than 1000 μm, optionally not more than 500 μm, optionally not more than 250 μm or not more than 100 μm. In some embodiments, the first and/or the second surface of the optical composite component deviate from the plane by not more than 1 μm, optionally not more than 500 nm, optionally not more than 300 nm, optionally not more than 150 nm or not more than 120 nm, optionally not more than 100 nm and optionally not more than 80 nm or not more than 70 nm, optionally not more than 60 nm or not more than 50 nm.

Optionally, “being planar” or “planar” in relation to the optically relevant regions of the surfaces of the composite component means: that the optically relevant regions of the first and/or the second surfaces of the composite component deviate from the plane by not more than 10 μm, optionally not more than 5 μm, optionally not more than 2 μm or not more than 1 μm. In some embodiments, the optically relevant regions of the first and/or the second surface of the optical composite component deviate from the plane by not more than 500 nm, optionally not more than 300 nm, optionally not more than 150 nm or not more than 120 nm, optionally not more than 100 nm and optionally not more than 80 nm or not more than 70 nm, optionally not more than 60 nm or 50 nm.

A “plane” of a surface under consideration is defined by approximating a surface by a regression of a mathematically perfect two-dimensional plane in such a way that the deviations of the real topography of the surface under consideration from the regression plane in both spatial directions are minimized.

The height or depression of deviations of the plane thus ascertained is determined by measuring the distance of a point (optionally the highest point of an elevation or the lowest point of a depression) from the plane along the normal vector of the plane. Elevations or depression can be ascertained, for example, by AFM measurements.

Due to manufacturing, but independent of the specific manufacturing method, the first and/or the second surface of the at least one stack and/or the first and/or the second surface of the optical composite component provided according to the invention may deviate from the ideal planes, in particular elevations and depressions. Such deviation can occur in particular in abrasive processes, such as grinding, lapping or polishing of the respective surfaces in the manufacture of the optical composite component, especially in the partial regions of the surface which differ in their hardness, their modulus of elasticity, their elongation-at-break behaviour, their glass transition temperature T_{g} or their tensile strength.

In the optical composite component provided according to the invention, such deviations occur in particular in the regions of the surface which are formed from the first or second surface of the at least one stack and therefore interface surfaces comprising at least one inorganic coating and/or an adhesive layer.

In some embodiments, the first and/or the second surface of the at least one stack optionally has deviations from the plane in the range of 5 nm to 1 μm, optionally from 5 nm to 500 nm, optionally from 10 nm to 300 nm or from 10 nm to 150 nm, optionally from 20 nm to 100 nm and optionally from 20 nm to 60 nm.

Deviations from the plane are optionally partial regions of a surface which are increased by a height H relative to the corresponding plane, hereinafter also called “elevation” or “bump”, or are reduced by a depth T, hereinafter also called “depression” or “dig-in”.

The height H denotes the maximum height of an elevation or deviation, the depth T denotes the maximum depth of a depression or deviation, i.e. the height H and the depth T respectively describe the maximum deviation from the plane of the respective surface.

Optionally, the first and/or the second surface of the at least one stack satisfy at least one of the following conditions:
i) no deviation from the plane of more than 300 nm, wherein the deviation may be an elevation with a height H or a depression with a depth T;
ii) no elevation of more than 200 nm, or
iii) no depression greater than 300 nm.

Optionally, the first and/or the second surface of the at least one stack satisfy at least one of the following conditions:
i) no deviation from the plane of more than 50 nm, wherein the deviation may be an elevation with a height H or a depression with a depth T;
ii) no elevation of more than 50 nm, or
iii) no depression greater than 100 nm.

Deviations from planes within the meaning of the present invention optionally have a length L and a width B, the length optionally being at least 5 nm, optionally at least 20 nm, optionally at least 50 nm, optionally at least 100 nm or 500 nm or optionally at least 5 μm, optionally at least 10 μm, optionally at least 500 μm, optionally at least 1000 μm, and/or the width being at least 5 nm, optionally at least 10 nm, optionally at least 20 nm, optionally at least 50 nm or at least 150 nm, optionally at least 500 nm, optionally at least 1000 nm. Optionally, the length L is not more than 100 mm, optionally not more than 50 mm, and/or the width B is not more than 3000 nm, optionally not more than 2000 nm.

In the optical composite component provided according to the invention, such deviations occur alternatively or additionally, in particular at the interfaces between the regions of the surface of different optical and/or optically non-relevant components, in particular at the interfaces in regions of the surface which comprise the surfaces of components of different materials and/or adhesive layers.

Interfaces within the meaning of the invention are the regions of the surface of the composite component between the edge of a first component and the edge of a directly adjoining, second component. Such interfaces are found in the composite component, for example, in the regions of the surface of the composite component, at which a stack directly adjoins a further stack, a stack directly adjoins a further optical component, in particular a polarization-optical element, a stack directly adjoins an optically non-relevant component, a further optical component, in particular, a polarization-optical element, directly adjoins an optically non-relevant component, or an optically non-relevant component adjoins an optical non-relevant component, and in regions in which a substrate of a stack adjoins a further substrate of the stack.

In a further aspect, the invention comprises the optical composite component provided according to the invention as an optical light-guide element or in an optical light-guide element, in particular for augmented reality applications.

The invention will be described in more detail hereinafter with reference to the figures and without limitation thereto. The same reference signs denote identical or similar elements.

In the detailed description below, the same reference signs in the different embodiments refer to the same or equivalent assemblies and components. Insofar as there are significant functional deviations, these are explained in more detail in each case with reference to the embodiment concerned.

FIG. 1 shows schematically the side view of an embodiment of the optical composite component 1, consisting of the at least one stack 10. The optical composite component 1 or the at least one stack 10 comprises two substrates 2. The first substrate 21 comprises a surface which is provided with an inorganic coating 3, wherein the inorganic coating 3 has a single-layer or multi-layer coating 30 and a top layer 31. In the illustrated embodiment, the second substrate 22 has no inorganic coating 3. The two substrates 21, 22 are bonded to each other via the full surface by an adhesive layer 4. The adhesive layer adjoins the top layer 31 of the inorganic coating of the first substrate 21 and the surface of the second substrate 22. The stack 10 has a first surface 80 and a second surface 90, which are optionally parallel to each other and which, in the present embodiment correspond to the first surface 180 and the second surface 190 of the composite component 10. The first surface 80, 180 is located in a first plane 280, the second surface 90, 190 is located in a second plane 290.

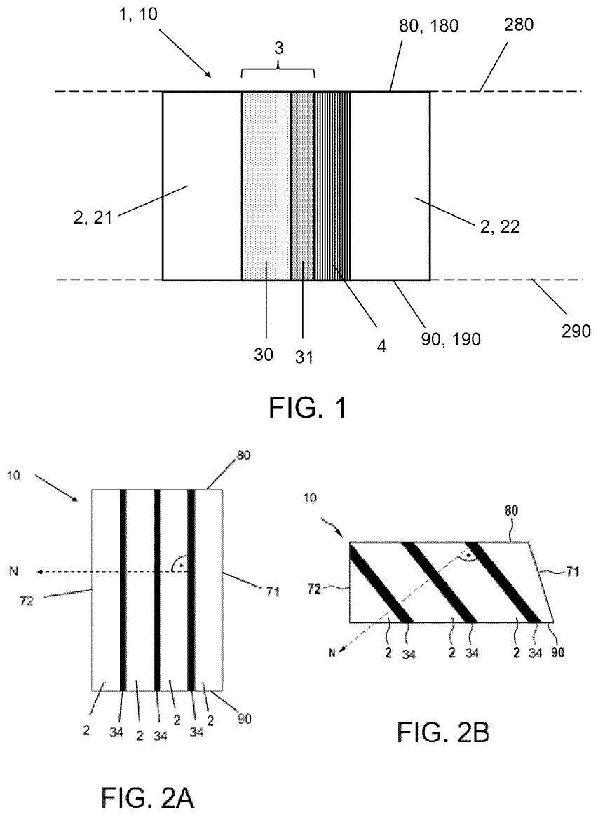

FIG. 2A and FIG. 2B illustrate the stack direction in different embodiments of the at least one stack 10. FIG. 2A shows a stack 10 which has a first surface 80 and a second surface 90 as well as a first side surface 71 and a second side surface 72. The stack 10 has in alternation substrates 2 and an interface 34, which is formed by an inorganic coating 3 and an adhesive layer 4. The stacking of the substrates 2 takes place from the first side surface 71 to the second side surface 72 of the stack along the normal vector N of the interfaces 34. The stack 10 is a so-called “straight” stack, wherein the angle between the normal vector N and the first surface 80 and/or the second surface 90 is a right angle.

FIG. 2B shows a so-called skewed stack 10, which has a first surface 80 and a second surface 90 as well as a first side surface 71 and a second side surface 72. The stack 10 has in alternation substrates 2 and an interface 34, which is formed by an inorganic coating 3 and an adhesive layer 4. The stacking of the substrates 2 takes place from the first side surface 71 to the second side surface 72 of the stack along the normal vector N of the interfaces 34. The stack 100 is a so-called “skewed” stack, wherein the angle between the normal vector N and the first surface 80 and/or the second surface 90 is not 90°.

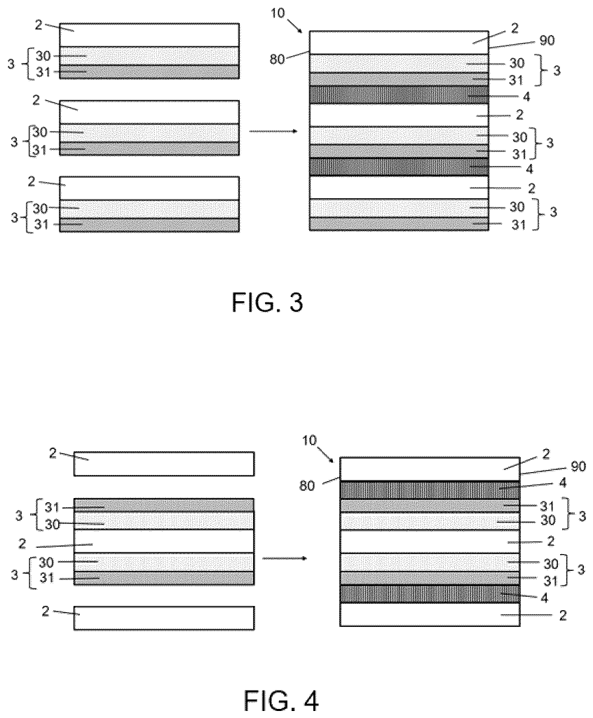

FIG. 3 shows the sequence of layers in an embodiment of the at least one stack 10, having a first surface 80 and a second surface 90, which in alternation comprises substrates 2, inorganic coating 3 and adhesive layers 4. The stack 10 is produced by the successive connecting of substrates 2, which each have a surface, which is provided with an inorganic coating 3, by means of full-surface adhesive layers 4.

FIG. 4 shows the layer sequence in an alternative embodiment of the at least one stack 10, having a first surface 80 and a second surface 90, which in alternation has substrates 2 and inorganic coating 3 and further comprises adhesive layers 4. The stack 10 is produced by the successive connecting of substrates 2, which each have two surfaces, which are provided with an inorganic coating 3 and substrates 2, which have two uncoated surfaces, by full-surface adhesive layers 4.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE SIGNS

1 Composite component
2 Substrate
3 Inorganic coating
4 Adhesive
10 Stack
30 Coating
31 Top layer of the coating
34 Interface
80 First surface of the stack
90 Second surface of the stack
180 First surface of the composite
190 Second surface of the composite
280 First plane
290 Second plane

What is claimed is:

1. An optical composite component for use as an optical light-guide element or in an optical light-guide element, comprising:
a first surface;
a second surface;
at least one stack with a first surface and a second surface, the at least one stack comprising two or more substrates connected to one another using an adhesive layer, wherein at least one surface of at least one substrate has at least one inorganic coating, wherein the two or more substrates are arranged in such a way that the substrates and the at least one inorganic coating are alternately arranged in a stack direction of the at least one stack, wherein an angle between a normal vector of the first surface and/or the second surface of the at least one stack and the stack direction is not 0°, wherein the first surface of the optical composite component comprises the first surface of the at least one stack and/or the second surface of the optical composite component comprises the second surface of the at least one stack, wherein the at least one inorganic coating has at least two layers, the at least two layers comprising a top layer comprising SiO₂.

2. The optical composite component of claim 1, wherein both surfaces of the at least one substrate have at least one inorganic coating.

3. The optical composite component of claim 1, wherein the at least one inorganic coating has 2 to 100 layers.

4. The optical composite component of claim 1, wherein the at least one inorganic coating has a thickness of 200 nm to 3000 nm.

5. The optical composite component of claim 1, wherein the at least one inorganic coating has a refractive index, which corresponds to a refractive index of the at least one substrate.

6. The optical composite component of claim 5, wherein a ratio of the refractive index of the at least one substrate to the refractive index of the at least one inorganic coating is in a range of 0.8 to 1.25.

7. The optical composite component of claim 1, wherein the top layer of the at least one inorganic coating has a thickness of 1 to 500 nm.

8. The optical composite component of claim 1, wherein the two or more substrates comprise a glass, a glass ceramic, an optical ceramic, or a plastic.

9. The optical composite component of claim 1, wherein the two or more substrates have a thickness of 0.2 mm to 2.0 mm.

10. The optical composite component of claim 1, wherein the two or more substrates of the at least one stack comprises 2 to 50 substrates.

11. The optical composite component of claim 1, wherein the adhesive layer is made of a light-curing adhesive.

12. The optical composite component of claim 11, wherein the light-curing adhesive is a UV-curing adhesive.

13. The optical composite component of claim 1, wherein the adhesive layer has a layer thickness of 10 nm to 20 μm.

14. The optical composite component of claim 1, wherein the adhesive layer has a refractive index which deviates from a refractive index of the two or more substrates by not more than 0.005.

15. The optical composite component of claim 1, comprising at least one further stack and/or at least one further optical component selected from the group consisting of optical filters, interference filters, mirrors, optical light-guide elements, and polarization-optical elements.

16. The optical composite component of claim 1, wherein at least one of the following is satisfied:
i) the first surface and/or the second surface of the optical composite component has a roughness R_{q} of <5 nm;
ii) the optical composite component has, based on the first surface and the second surface, a TTV of less than 10 μm;
iii) the optical composite component has, based on the first surface and the second surface, a warp of <100 μm; or
iv) the optical composite component has, based on the first surface and the second surface, a bow of <100 μm.

17. A use of the optical composite component of claim 1 as an optical light-guide element or in an optical light-guide element.
